(19) United States
(12) Patent Application Publication
(10) Pub. No.: US 2012/0120018 A1
(43) Pub. Date: May 17, 2012

(54) DISPLAY DEVICE HAVING CAPACITIVE TOUCH SCREEN PANEL

(75) Inventors: Myung Geun KOH, Suwon-si (KR); Yi Kyu MIN, Yongin-si (KR); Kyung Goo LEE, Seoul (KR); Byoung Il SON, Suwon-si (KR)

(73) Assignee: SAMSUNG ELECTRONICS CO. LTD., Suwon-si (KR)

(21) Appl. No.: 13/079,295

(22) Filed: Apr. 4, 2011

(30) Foreign Application Priority Data
Nov. 15, 2010 (KR) 10-2010-0113162

(51) Int. Cl. G06F 3/045

(52) U.S. Cl. 345/174

(57) ABSTRACT

A display device including a capacitive touch screen panel is provided. The display device includes a touch screen panel sensor film including an upper Indium Tin Oxide (ITO) layer and a lower ITO layer, and a touch screen Flexible Printed Circuit Board (FPCB), wherein an air path direction modification unit is formed on a passageway of an air path to modify a direction of the air path, the air path being formed between the upper ITO layer and the touch screen FPCB.

### PRIORITY

This application claims the benefit under 35 U.S.C. §119(a) of a Korean patent application filed on Nov. 15, 2010 in the Korean Intellectual Property Office and assigned Serial No. 10-2010-0113162, the entire disclosure of which is hereby incorporated by reference.

### BACKGROUND OF THE INVENTION

1. Field of the Invention

The present invention relates to a display device having a capacitive touch screen panel. More particularly, the present invention relates to a display device having a capacitive touch screen panel in which damage to an Indium Tin Oxide (ITO) pattern of a touch screen panel sensor film is prevented when performing an ElectroStatic Discharge (ESD) test.

2. Description of the Related Art

Recently, in order to provide a light and thin portable terminal with a wide display area, a touch screen technique has been widely used in the portable terminal. While the touch screen technique can be implemented in a resistive touch screen panel or a capacitive touch screen panel, there are recent increased demands for the capacitive touch screen panel due to its durability, accurate touch sensitivity, and higher optical characteristics.

FIG. 1 illustrates a bottom view of an upper Indium Tin Oxide (ITO) layer and a touch screen Flexible Printed Circuit Board (FPCB) of a display device having a capacitive touch screen panel according to the related art. FIG. 2 is a partial cross sectional view taken along line A-A′ of FIG. 1 illustrating the display device having the capacitive touch screen panel according to the related art.

Referring to FIGS. 1 and 2, the display device 100 having the touch screen panel includes a display 110, a touch screen panel sensor film 120 laminated on an upper surface of the display 110, a window 130 laminated on an upper surface of the touch screen panel sensor film 120, and a touch screen FPCB 140 that is electrically connected to ITO patterns 123 and 124 of the touch screen panel sensor film 120. The touch screen panel sensor film 120 includes a lower ITO layer 121 and an upper ITO layer 122. Also, an interval G of 0.2 mm is formed between the upper ITO layer 122 and the touch screen FPCB 140 to facilitate assembly thereof and prevent damage due to external impact.

Similar to other general portable terminals, an ElectroStatic Discharge (ESD) test is performed on a portable terminal including the conventional display device 100 having the capacitive touch screen panel according to the related art to determine whether the portable terminal can endure a preset level of static electricity that may occur in a real environment. However, when applying an ESD to a side surface of the conventional display device 100 having the capacitive touch screen panel, especially close to an air path 150, which is formed by the interval G between the upper ITO layer 122 and the touch screen FPCB 140, the ESD is caused to enter into the air path 150 since the air path 150 is formed in a ‘-’ shape when viewed from a side angle, as illustrated in FIG. 1. Therefore, the ITO pattern 123, which contacts the air path 150, can be damaged due to a high voltage applied thereto.

### SUMMARY OF THE INVENTION

An aspect of the present invention is to address at least the above-mentioned problems and/or disadvantages and to provide at least the advantages described below. Accordingly, an aspect of the present invention is to provide a display device having a capacitive touch screen panel that can prevent damage to an Indium Tin Oxide (ITO) pattern when applying an ElectroStatic Discharge (ESD) to a side surface thereof.

According to an aspect of the present invention, a display device having a capacitive touch screen panel is provided. The display device includes, a touch screen panel sensor film including an upper ITO layer and a lower ITO layer, and a touch screen Flexible Printed Circuit Board (FPCB), wherein an air path direction modification unit is formed on a passageway of an air path to modify a direction of the air path, the air path being formed between the upper ITO layer and the touch screen FPCB.

According to another aspect of the present invention, a display device including a capacitive touch screen panel is provided. The device includes an air path direction modification unit that is formed on a passageway of an air path to modify a direction of the air path and formed by an external projection portion on both end terminals of an upper ITO layer of a touch screen panel sensor film, wherein the air path being formed between the upper ITO layer of the touch screen panel sensor film and a touch screen FPCB.

According to the present invention, the air path direction modification unit for modifying the direction of the air path may be formed on the passageway of the air path formed between the upper ITO layer and the touch screen FPCB so that damage to the ITO pattern can be prevented when applying the ESD to the side surface of the display device having the capacitive touch screen panel.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates a bottom view of an upper Indium Tin Oxide (ITO) layer and a touch screen Flexible Printed Circuit Board (FPCB) of a display device having a capacitive touch screen panel according to the related art;

FIG. 2 is a partial cross sectional view taken along line A-A′ of FIG. 1 illustrating the conventional display device having the capacitive touch screen panel according to the related art;

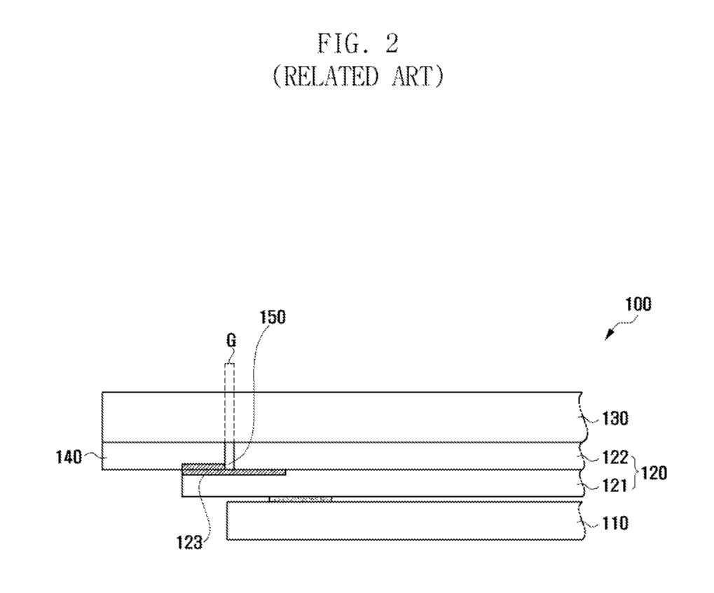

FIG. 3 illustrates a bottom view of an upper ITO layer and a touch screen FPCB of a display device having a capacitive touch screen panel according to an exemplary embodiment of the present invention;

FIG. 4 is a partial cross sectional view taken along line B-B′ of FIG. 3 illustrating a display device having a capacitive touch screen panel according to an exemplary embodiment of the present invention; and

FIG. 5 is a bottom view illustrating a lower ITO layer of FIG. 4 according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

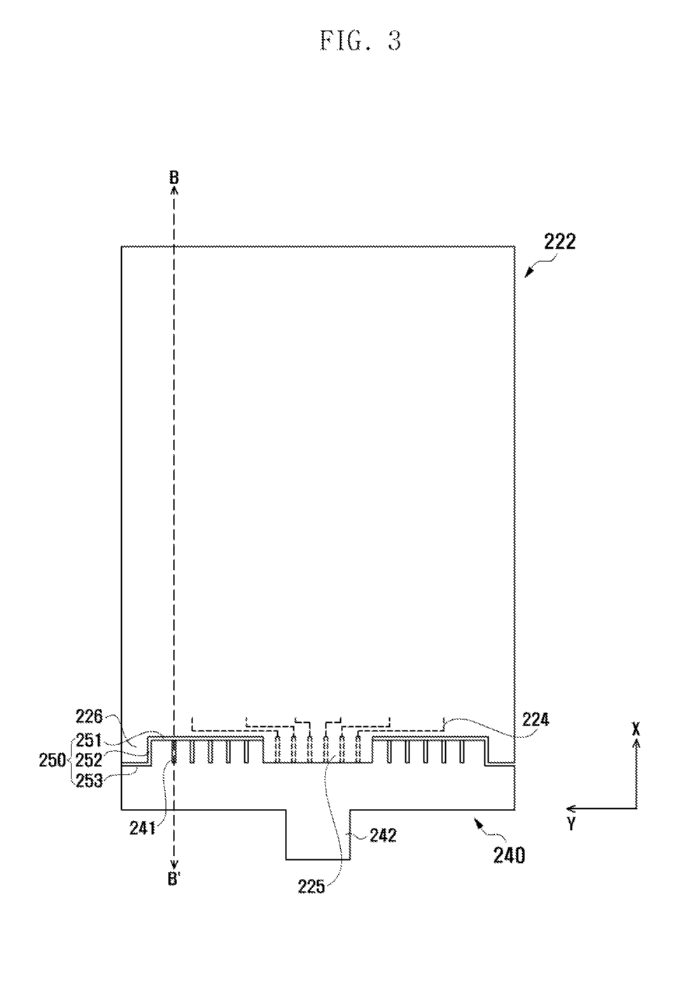

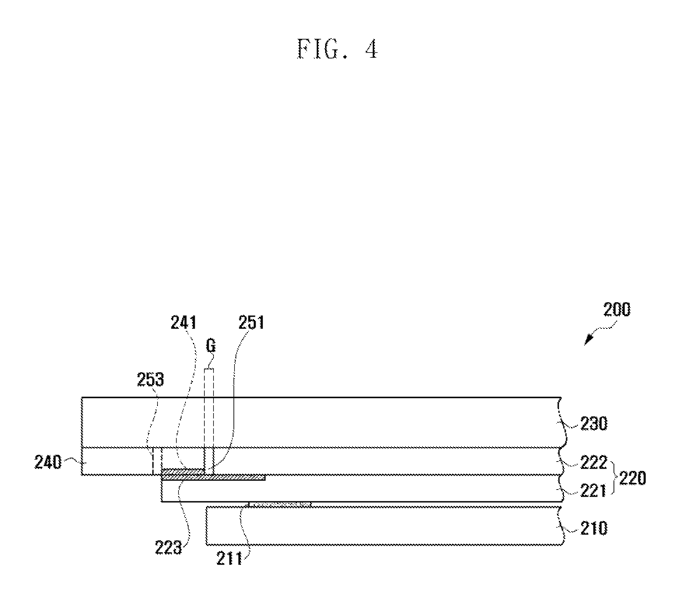

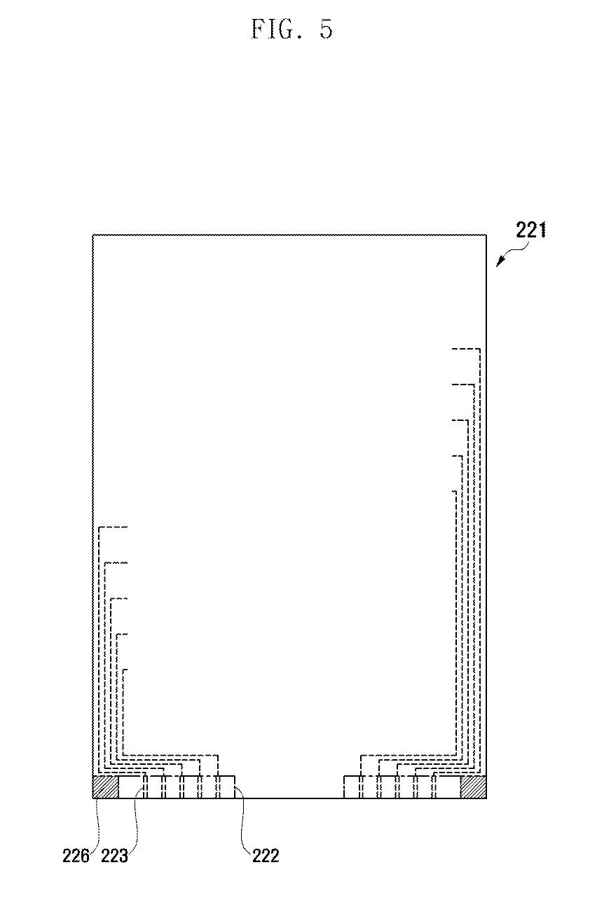

FIG. 3 is a bottom view illustrating an upper Indium Tin Oxide (ITO) layer and a touch screen Flexible Printed Circuit Board (FPCB) of a display device having a capacitive touch screen panel according to an exemplary embodiment of the present invention. FIG. 4 is a partial cross sectional view taken along line B-B′ of FIG. 3 illustrating a display device having a capacitive touch screen panel according to an exemplary embodiment of the present invention. FIG. 5 is a bottom view illustrating a lower ITO layer shown in FIG. 4 according to an exemplary embodiment of the present invention. In FIG. 5, a shadowed area represents an external projection portion 226 of an upper ITO layer 222 and an alternated long and short dash line represents an end line of the upper ITO layer 222.

Referring to FIGS. 3 through 5, the display device 200 having a capacitive touch screen panel includes a display 210, a touch screen panel sensor film 220, a window 230 and a touch screen FPCB 240.

The display 210 is used to display images and includes a Liquid Crystal Display (LCD) or an Active Matrix Organic Light Emitting Diode (AMOLED).

The touch screen panel sensor film 220 is laminated on an upper surface of the display 210 to recognize a user's touch. A double sided tape 211 is attached to a bottom surface of the touch screen panel sensor film 220 for fixing the touch screen panel sensor film 220 to the display 210. The touch screen panel sensor film 220 includes a lower ITO layer 221 and the upper ITO layer 222, wherein the upper ITO layer 222 is laminated on an upper surface of the lower ITO layer 221. The lower ITO layer 221 and the upper ITO layer 222 are engaged to each other via a hot bar bonding. In an exemplary implementation, the upper ITO layer 222 is a Y axis ITO layer for detecting a Y axis coordinate of a touch point and the lower ITO layer 221 is an X axis ITO layer for detecting an X axis coordinate of the touch point. The lower ITO layer 221 and the upper ITO layer 222 include a polyethylene terephthalate (PET) film which has ITO patterns 223 and 224 formed thereon, respectively.

The upper ITO layer 222 has a central projection portion 225 for electrically connecting the ITO pattern to the touch screen FPCB 240. Also, the external projection portion 226 is formed on both end terminals of the ITO layer 222 that face each other relative to the central projection portion 225. As illustrated in FIGS. 3 and 5, the ITO pattern 224 of the upper ITO layer 222 is not formed on the external projection portion 226. Also, the external protrusion portion 226 does not overlap the ITO pattern 223 of the lower ITO layer 221.

The window 230, which is used to protect the touch screen panel sensor film 220 and allow a user to point to an object thereon, is laminated on an upper portion of the touch screen panel sensor film 220. Since the present invention is applicable to the capacitive touch screen panel of the display device, the window 230 preferably comprises glass.

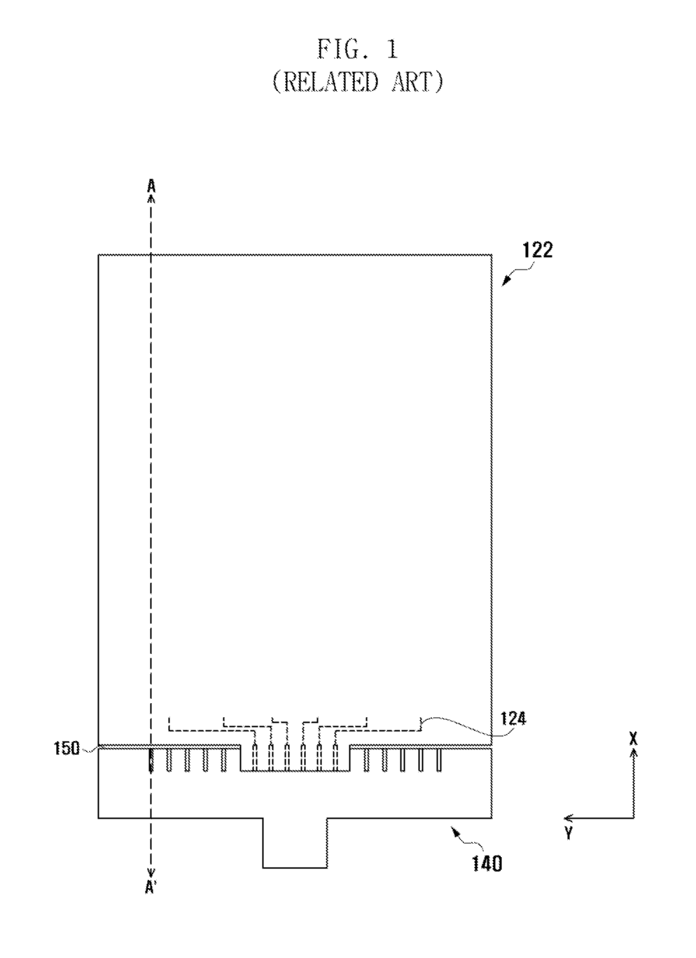

The touch screen FPCB 240, which is used to transmit a signal received from the ITO patterns 223 and 224 of the touch screen panel sensor film 220 to a controller (not illustrated), is positioned below the window 230. An electrode pattern 241 is formed on a bottom surface of the touch screen FPCB 240 to electrically connect with the ITO pattern of the touch screen panel sensor film 220. The touch screen FPCB 240 may be connected to a display FPCB (not illustrated) or a main board (not illustrated) through a connection unit 242. In an exemplary implementation, compared with the conventional touch screen FPCB 140 illustrated in FIG. 1, a concave portion is formed on both end terminals of the touch screen FPCB 240 in which the external projection portion 226 of the upper ITO layer 222 is positioned.

Hereinafter, an air path 250 formed between the upper ITO layer 222 and the touch screen FPCB 240 is described. The air path 250 includes an interior portion 251, an air path direction modification unit 252, and an exterior portion 253. The interior portion 251 extends along a Y axis. As illustrated in FIG. 4, the ITO pattern 223 of the lower ITO layer 221 contacts a bottom portion of the interior portion 251. The air path direction modification unit 252 is positioned on a passageway of the air path to modify a direction of the air path. An interior terminal of the air path direction modification unit 252 is connected to an exterior terminal of the interior portion 251. In an exemplary implementation, the air path direction modification unit 252 extends along an x axis. However, it should be noted that the air path direction modification unit 252 may have a straight line that is inclined outwardly or a curve. The exterior portion 253 connects an exterior terminal of the air path 250 and an exterior terminal of the air path direction modification unit 252. In an exemplary implementation, the exterior portion 253 extends along the Y axis.

In an exemplary implementation, the external projection portion 226, which comprises PET and does not include the ITO pattern, is formed on both end terminals of the upper ITO layer 222 to provide the air path direction modification unit 252 for modifying the direction of the air path 250. Accordingly, when an ElectroStatic Discharge (ESD) is applied to a side surface of the display device 200 having a capacitive touch screen panel, especially close to the exterior terminal of the air path 250, the ESD is not caused to enter into the air path 250 because the passageway of the air path 250 is not shaped as ‘-’ but has a curve. Also, even in a case where the ESD is applied to the touch screen FPCB 240 near the air path 250, damage due to the ESD can be prevented because the touch screen FPCB 240 is connected to a grounding device (not illustrated). Thus, when applying the ESD to the side surface of the display device having the capacitive touch screen panel, damage to the ITO pattern or damage to an Integrated Circuit (IC) or a circuit board can be prevented.

While the invention has been shown and described with reference to certain exemplary embodiments thereof, it will be understood by those skilled in the art that various changes in form and details may be made therein without departing from the spirit and scope of the invention as defined in the appended claims and their equivalents.

What is claimed is:

1. A display device including a capacitive touch screen panel, the device comprising:
a touch screen panel sensor film including an upper Indium Tin Oxide (ITO) layer and a lower ITO layer; and
a touch screen Flexible Printed Circuit Board (FPCB), wherein an air path direction modification unit is formed on a passageway of an air path to modify a direction of the air path, the air path being formed between the upper ITO layer and the touch screen FPCB.

2. The device according to claim 1, wherein the air path direction modification unit is formed by an external projection portion positioned on both end terminals of the upper ITO layer.

3. The device according to claim 1, wherein the air path comprises an exterior portion configured to connect an exterior terminal of the air path with an exterior terminal of the air path direction modification unit.

4. The device according to claim 1, wherein the air path comprises an interior portion connected to an interior terminal of the air path direction modification unit, and
wherein the interior portion extends along a Y axis.

5. The device according to claim 2, wherein the touch screen FPCB comprises a concave portion that is formed in an area in which the external projection portion is positioned.

6. The device according to claim 1, wherein the upper ITO layer comprises a Y axis ITO layer to detect a Y axis coordinate of a touch point.

7. The device according to claim 1, wherein the lower ITO layer comprises an X axis ITO layer to detect an X axis coordinate of a touch point.

8. The device according to claim 4, wherein the lower ITO layer comprises an ITO pattern that contacts a bottom portion of the interior portion of the air path.

9. The device according to claim 1, wherein a central projection portion is formed on the upper ITO layer to electrically connect an ITO pattern of the upper ITO layer with the touch screen FPCB.

10. A display device including a capacitive touch screen panel, the device comprising:
an air path direction modification unit that is formed on a passageway of an air path to modify a direction of the air path and formed by an external projection portion on both end terminals of an upper Indium Tin Oxide (ITO) layer of a touch screen panel sensor film,
wherein the air path being formed between the upper ITO layer of the touch screen panel sensor film and a touch screen Flexible Printed Circuit Board (FPCB).

11. The device of claim 10, wherein the touch screen panel sensor film comprises a lower ITO layer.

12. The device according to claim 10, wherein the air path comprises an exterior portion configured to connect an exterior terminal of the air path with an exterior terminal of the air path direction modification unit.

13. The device according to claim 10, wherein the air path comprises an interior portion connected to an interior terminal of the air path direction modification unit, and
wherein the interior portion extends along a Y axis.

14. The device according to claim 10, wherein the touch screen FPCB comprises a concave portion that is formed in an area in which the external projection portion is positioned.

15. The device according to claim 11, wherein the upper ITO layer comprises a Y axis ITO layer to detect a Y axis coordinate of a touch point.

16. The device according to claim 11, wherein the lower ITO layer comprises an X axis ITO layer to detect an X axis coordinate of a touch point.

17. The device according to claim 11, wherein the lower ITO layer comprises an ITO pattern that contacts a bottom portion of the interior portion of the air path.

18. The device according to claim 11, wherein a central projection portion is formed on the upper ITO layer to electrically connect an ITO pattern of the upper ITO layer with the touch screen FPCB.
